(19) United States
(12) Patent Application Publication
(10) Pub. No.: US 2005/0242031 A1
(43) Pub. Date: Nov. 3, 2005

(54) Method for the production of anhydrous tert butanol

(75) Inventors: Dieter Reusch, Marl (DE); Wilfried Buschken, Haltern am See (DE); Andreas Beckmann, Recklinghausen (DE); Franz-Felix Kuppinger, Marl (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: OXENO OLEFINCHEMIE GMBH, Marl (DE)

(21) Appl. No.: 10/526,763

(22) PCT Filed: Aug. 6, 2003
(86) PCT No.: PCT/EP03/08688

§ 371 Date: Mar. 7, 2005

(30) Foreign Application Priority Data
Sep. 10, 2002 (DE) 102 41 762.8

(51) Int. Cl. B01D 61/36

(52) U.S. Cl. 210/640; 210/650; 210/774; 203/39

(57) ABSTRACT

The invention relates to a process for producing anhydrous TBA from TBA/water mixtures.

The invention relates to a process for producing anhydrous tert-butanol (TBA) from water-containing mixtures, in which at least part of the water is separated off by means of a membrane.

tert-Butanol (TBA) is an important product produced on a large industrial scale and is used as solvent and as intermediate for the preparation of methyl methacrylate. It is a precursor for the preparation of peroxides such as peroxy ketals, peresters or dialkyl peroxides having at least one tertiary butyl group. These compounds are used as oxidants and as initiators for free-radical reactions, for example olefin polymerization or crosslinking of polymers. TBA serves as intermediate for obtaining pure isobutene from isobutene mixtures. Furthermore, it is a reagent for the introduction of tertiary butyl groups. Its alkali metal salts are strong bases which are employed in many syntheses.

TBA can be prepared by oxidation of isobutane or is obtained as coproduct in the epoxidation of olefins using tert-butyl peroxide. The most important route for the preparation of TBA is the acid-catalyzed addition of water onto isobutene, as described, for example, in Ullmanns Encyclopedia of Industrial Chemistry 5^{th} Edition, pages 462-473. This gives water-containing TBA. These mixtures can, depending on the TBA content, be separated by simple distillation into a TBA/water homoazeotrope containing about 13% by weight of water plus water or pure TBA. Owing to its water content, the TBA/water azeotrope is not suitable for all uses of TBA. For example, the water content of the TBA must be no higher than 1.5% by mass if the TBA is to be used as a component of four-stroke fuels.

A number of industrial processes are known for the complete dewatering of TBA/water mixtures, for example liquid-liquid extraction, extractive distillation or azeotropic distillation using an entrainer (U.S. Pat. No. 6,166,270; U.S. Pat. No. 4,239,926; DD 106 026; CS 148 207).

These processes require the presence of a solvent. Thus, halogenated hydrocarbons such as chloroform, bromobenzene or trichloroethylene are used in liquid-liquid extraction, glycols such as ethylene glycol, diethylene glycol or propylene glycol or aromatic hydrocarbons such as xylenes are used in dewatering by means of extractive distillation and n-pentane, methyl tert-butyl ether, petroleum ether or a hexane/heptane mixture, for example, are used in the removal of water by azeotropic distillation.

A study of the dewatering of TBA using hydrophilic membranes shows that a largely anhydrous TBA (retenate) is obtained through the membrane only at low, industrially unacceptable mass flows of water (Tatiana Gallego-Lizon, Emma Edwards, Giuseppe Lobiundi, Luisa Freitas dos Santos, Dehydration of water/t-butanol mixtures by pervaporation: comparative study of commercially available polymeric, microporous silica and zeolite membranes, Journal of Membrane Science 197 (2002), 309-319).

Processes for separation of materials by pervaporation over membranes are commercially available (e.g. from Sulzer). Here, the material to be separated off is obtained in vapor form as permeate. To achieve a high degree of separation, pervaporation is carried out in a plurality of membrane modules connected in series. It is known that a TBA/water mixture can be dewatered by means of a membrane. A TBA/water azeotrope is a possible feed. A disadvantage of dewatering by means of a membrane is that complete or virtually complete dewatering is associated with a high energy consumption, since the removal of water becomes increasingly difficult as the water concentration decreases. In addition, complete dewatering is not possible by means of a membrane alone. Since both water and TBA are small molecules and polar, protic liquids, the membrane is not 100% selective for the passage of water, i.e. TBA is separated off together with the water.

All these processes have the disadvantages that they require a high investment, incur high operating costs or give a TBA having an unacceptably high water content.

It is therefore an object of the invention to develop a cheaper process for separating off water from water-containing TBA.

It has now been found that water can be removed efficiently from aqueous TBA solutions by a process which comprises at least one distillation stage and one membrane separation stage. The invention accordingly provides a process for separating off water from a tert-butanol (TBA)/water mixture by
a) distilling the TBA/water mixture to give a TBA/water azeotrope and a water-free TBA stream,
b) separating the water from the TBA/water azeotrope by means of a membrane to give a stream comprising predominantly TBA and a stream comprising predominantly water and
c) recirculating the stream comprising predominantly TBA to the distillation of stage a).

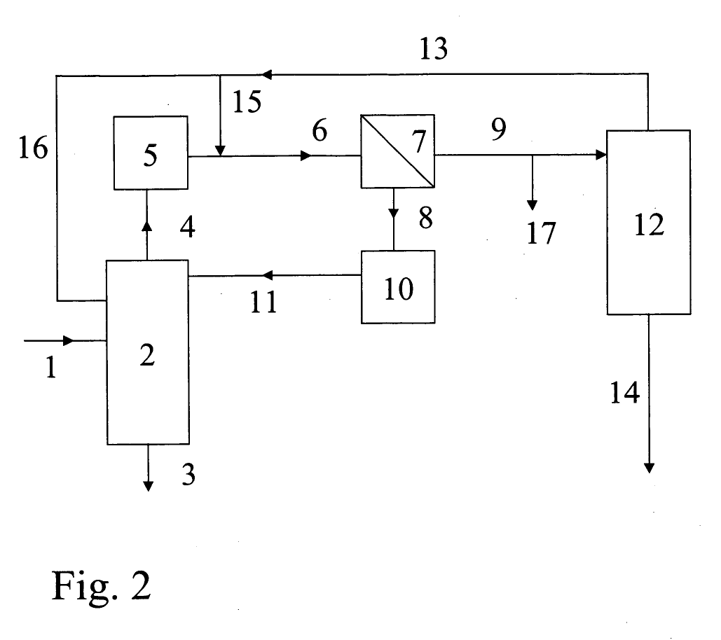

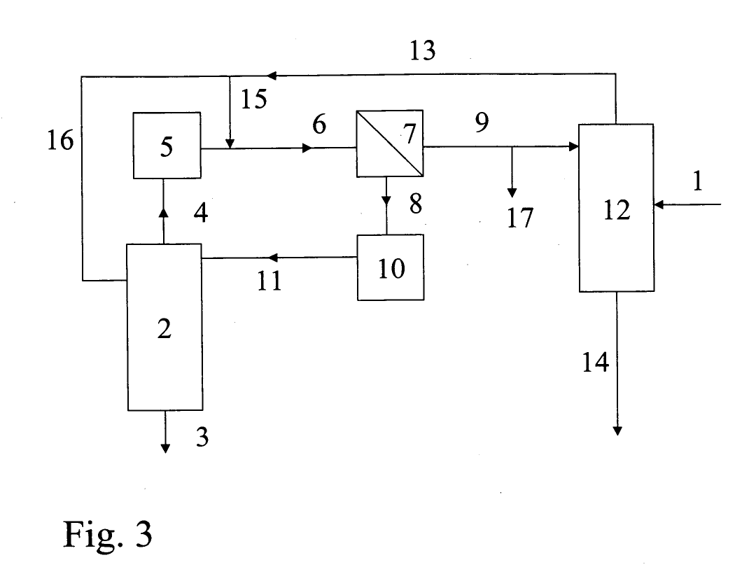

The process of the invention makes it possible to produce anhydrous TBA from TBA/water mixtures. The anhydrous TBA preferably has a residual water content of 10-5000 ppm by mass, in particular 200-800 ppm by mass, particularly preferably 400-600 ppm by mass. As by-product, residue streams which comprise predominantly water and can have a residual TBA content of from 10% by mass to less than 600 ppm by mass are obtained. In specific embodiments of the invention as shown in FIGS. 2 and 3, the TBA content of the water which has been separated off is less than 2000 ppm by mass, in particular less than 600 ppm by mass, preferably down to 1 ppm by mass.

The process of the invention can be carried out in a number of variants:

Prior to the distillation of stage a), the TBA/water mixture can be fractionated to give an aqueous bottom product and a TBA-containing top product which is fed to the distillation of stage a).

Furthermore, the recirculation of the stream comprising predominantly TBA of stage c) can be wholly or partly to the membrane separation of stage b).

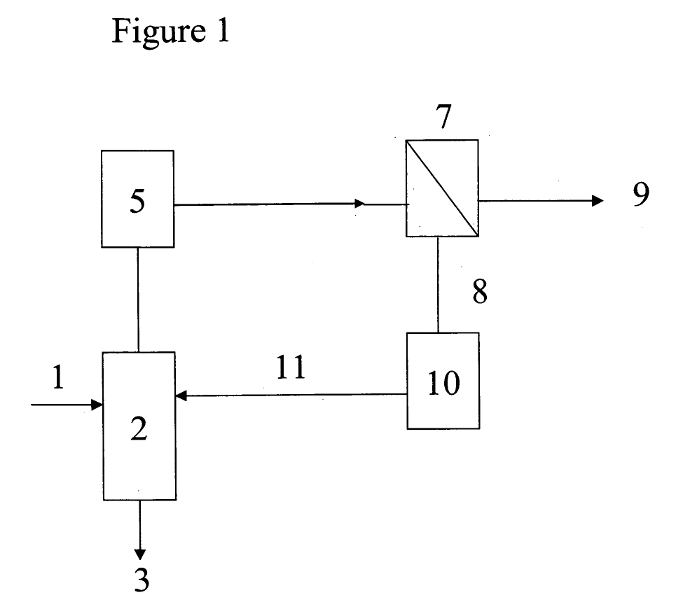

A block diagram of a process variant by means of which the dewatering of TBA by the process of the invention can be carried out is shown in FIG. 1. The aqueous TBA solution (1) is fed into the distillation column (2). The top product (4) (TBA/water homoazeotrope) is separated in the membrane unit (7) into a stream (9) comprising predominantly water and the stream (8) which comprises predominantly TBA and has a water content less than that of the top product (4). Depending on whether the removal of water in the membrane unit (7) occurs from the liquid or gaseous phase, the vapor (4) is condensed in the condenser (5) or condenser (10). The condensate (11) is returned to the distillation column (2).

FIG. 2 shows a process variant in which the stream (9) which has been separated off is separated in the column (12) into a TBA/water azeotrope (13), which is conveyed to the column (2), and water (14).

In the process of the invention as shown in FIG. 2, the TBA/water azeotrope (13) from column (12) can optionally be fed via line (15) into the membrane unit (7). Furthermore, part of the TBA/water azeotrope can be fed into the membrane unit (7) and the other part can be fed into the column (2).

Stream (17) represents a feed to the column (2) or an opportunity of bleeding off secondary components.

A block diagram of a further process variant is shown in FIG. 3. The aqueous TBA solution (1) is fed into the column (12). Water is taken off as bottom product (14). The top product (13) (TBA/water homoazeotrope) is fed via line (13) to the distillation column (2). Alternatively, all or part of this stream can also be fed to the membrane separation (7) using the lines (15) and/or (16). The top product (4) (TBA/water homoazeotrope) is separated in the membrane unit (7) into a stream (9) comprising predominantly water and a distillate (8) having a water content which is less than that of the top product (4). Depending on whether the water is separated off in the membrane unit (7) from the liquid or gaseous phase, the vapor (4) is condensed in the condenser (5) or condenser (10). The condensate (11) is returned to the first column (2). The aqueous permeate (9) which has been separated off can optionally be recirculated to the second column (12). A bleed stream can be taken off via line (17).

Customary components such as pumps, compressors, valves and vaporizers are not shown in the block diagrams, but are of course components of a plant.

The variants shown in FIGS. 1 and 2 are particularly useful for the work-up of TBA/water mixtures whose water content is less than that of the TBA/water azeotrope. The water which has been separated off contains up to 10% by mass of TBA in the process shown in FIG. 1. This process is advantageous when this stream can be utilized as such, for example as feed stock for the preparation of TBA by addition of water onto isobutene. On the other hand, the variant shown in FIG. 3 is advantageous for the dewatering of TBA mixtures having a high water content. In this variant, at least two columns are necessary.

In the process of the invention, the dewatering of TBA is carried out by a combination of at least one distillation and a separation over a membrane.

The removal of water from the water/TBA distillate by means of a membrane occurs by reverse osmosis (liquid distillate; liquid permeate), preferably by pervaporation (liquid distillate; gaseous permeate) or by vapor permeation (gaseous distillate; gaseous permeate). Furthermore, simultaneous pervaporation and vapor permeation are possible.

Commercial hydrophilic membranes are used for separating off water by pervaporation or vapor permeation. These can be polymer membranes or inorganic membranes.

In the process of the invention, it is possible to use, for example, polymer membranes from Sulzer Chemtech, CM-Celfa, GKSS or Sophisticated Systems (polyimide membrane). Examples are Pervap 2201, Pervap 2202, Pervap 2510 from Sulzer or 2S-DP-H018 from Sophisticated Systems. As inorganic membranes, it is possible to use, for example: SMS (Sulzer Chemtech); Silica (Pervatech); NaA (Mitsui or Smart Chemical).

The removal of water according to the invention is carried out in the temperature range from 20 to 200° C. over the inorganic membranes and in the temperature range from 20 to 150° C. over the polymer membranes. A preferred temperature range for both types of membrane is from 60 to 140° C.

In the process of the invention, the pressure of the distillate fed to the membrane unit (liquid, gaseous or as a mixed phase) is from 0.5 to 30 bar, preferably from 0.8 to 20 bar. The pressure on the permeate side of the membrane is from 0.001 to 1 bar.

In the case of polymer membranes, the differential pressure is from 0.01 to 20 bar, and in the case of inorganic membranes is from 0.01 to 30 bar; in particular, the differential pressures are in the range from 1 to 5 bar. The mass flow (kg of permeate per square meter of membrane surface per hour) is from 0.1 to 10 kg/m²/h, preferably from 1 to 8 kg/m²/h. The water separated off as permeate contains less than 10% by mass, in particular less than 5% by mass, very particularly preferably less than 3% by mass, of TBA.

This permeate, e.g. (9) in FIG. 1, can be used, for example, in a plant in which TBA is prepared by reaction of water with isobutene or with an isobutene-containing mixture.

Otherwise, it can be fed into the second distillation column, e.g. (12) in FIGS. 2 and 3.

The retentate obtained after the membrane separation has, depending on the membrane type, a water content of from 10% by mass to 10 ppm by mass, preferably from 8% by mass to 500 ppm by mass, particularly preferably from 5 to 0.5% by mass.

The separations by distillation are carried out in columns containing internals which comprise trays, rotating internals, random packing and/or ordered packing.

In the case of column trays, the following types are used:
Trays having holes or slots in the plate.
Trays having necks or chimneys which are covered by bubble caps or the like.
Trays whose plate has holes covered by movable valves.
Trays having special constructions.

In columns having rotating internals, the runback is either sprayed by means of rotating funnels or spread as a film over a heated tube wall by means of a rotor.

Irregular beds of various packing elements can be employed in the columns used in the process of the invention. They can comprise virtually any materials, e.g. steel, stainless steel, copper, carbon, stoneware, porcelain, glass, plastics, etc., and have various shapes, e.g. spheres, rings having smooth or profiled surfaces, rings having internal struts or openings through the wall, wire mesh rings, saddles and spirals.

Packing having a regular geometry can, for example, comprise metal sheets or woven meshes. Examples of such packing are Sulzer mesh packing BX made of metal or plastic, Sulzer lamella packing Mellapak made of sheet metal, high-performance packing such as Mella-pakPlus, structured packing from Sulzer (Optiflow), Montz (BSH) and Küihni (Rombopak).

The column which interacts with the membrane unit and from which the anhydrous TBA is taken off as bottom product generally has from 9 to 60, in particular from 9 to 30, theoretical plates. The feed plate depends on the composition of the feed. When a TBA/water azeotrope is fed in, it is preferably introduced at the 1st to 59th theoretical plate, in particular at the 1st to 29th theoretical plate (counted from the top).

The operating pressure of the first column is from 0.5 to 30 bar abs. (BARA), in particular from 1 to 7 BARA. The reflux ratio is in the range from 0.2 to 10, in particular from 0.6 to 5.

The second optional column from which water is taken off as bottom product preferably has from 6 to 30, in particular from 7 to 20, theoretical plates. The feed plate depends on the composition of the feed. For example, at a water content of 60% by mass, it is introduced at the 1st to 22nd theoretical plate (counted from the top).

The removal of water in the second column can be carried out at subatmospheric pressure, atmospheric pressure or superatmospheric pressure. A preferred pressure range is from 0.025 to 3 BARA, in particular from 0.05 to 1.2 BARA. The reflux ratio can be from 0.2 to 20, in particular from 0.5 to 10.

The process of the invention can be used to work-up any binary water/TBA mixtures to give anhydrous TBA, at water contents lower than in the TBA /water azeotrope advantageously according to the variants shown in FIGS. 1 and 2, otherwise advantageously according to the variant shown in FIG. 3.

Mixtures containing high boilers (substances having a boiling point higher than that of the water/TBA azeotrope) in addition to water and TBA can advantageously be worked up by the process of the invention when the high boilers do not form an azeotrope having a boiling point lower than that of the water/TBA azeotrope with water and/or TBA. In this case, an anhydrous TBA containing high boilers is obtained. This can optionally be worked up to give pure TBA, for example by distillation. As an alternative, as shown in the figures, a substream can be bled off to reduce the content of high boilers.

In principle, mixtures containing low boilers (substances having a boiling point lower than that of the TBA/water azeotrope), e.g. olefins or paraffins such as C₄-hydrocarbons, in addition to TBA and water can in principle also be worked up by the process of the invention. Since in this case the low boilers accumulate in the distillate, part of this has to be bled off continuously, leading to losses. It is advantageous to separate off the low boilers in a preliminary column in such a case.

The process of the invention can be used to work-up aqueous TBA solutions from various sources, for example aqueous crude TBA obtained in the addition reaction of water with isobutene-containing hydrocarbon streams.

The advantage of the process of the invention is that aqueous TBA mixtures can be dewatered without losses of material, without use of an auxiliary and with a low energy consumption.

The following examples illustrate the invention without restricting its scope which is defined by the description and the claims.

### EXAMPLES

### Example 1

The production of anhydrous TBA was carried out in a plant of the type shown in FIG. 2. The diameter of the first column was 80 mm and the diameter of the second column was 50 mm. The first column had 13 theoretical plates as a result of metal packing and the feed was introduced at the fifth theoretical plate. The second column had 10 theoretical plates as a result of metal packing and the feed was introduced at the fifth theoretical plate. The feed was composed of 9% of water and 91% of TBA and was fed into the first column. The vapor permeation was carried out using a Sulzer 2202 membrane from Sulzer. The stream numbers in following table were the same as in FIG. 1.

| | | | Concentration of the |
|---|---|---|---|
| Stream | | Mass flow | component to be |
| number | Stream description | [kg/h] | separated off |
| 1 | Fresh feed | 2.2 | |
| 3 | Pure TBA (bottoms | 1.99 | 100 ppm by |
| | from column 2) | | mass of water |
| 6 | Distillate | 12.9 | |
| 9 | Permeate | 0.22 | 3.7% by mass of TBA |
| 11 | Retentate | 12.68 | |
| 13 | Distillate | 0.01 | |
| 14 | Water which has been | 0.21 | 490 ppm by |
| | separated off (bottoms | | mass of TBA |
| | from column 12) | | |
| 1 + 11 + 13 | Feed to column 2 | 14.89 | |

The pressure of the distillate stream (6) at the membrane was 1 bar and the pressure of the permeate (9) at the membrane was 0.055 bar.

### Example 2

The production of anhydrous TBA was carried out in a plant of the type shown in FIG. 3. The construction of the columns corresponded to Example 1.

The feed was composed of 60% of water and 40% of TBA and was fed into the second column. The vapor permeation was carried out using a Sulzer 2202 membrane from Sulzer.

| | | | Concentration of the |
|---|---|---|---|
| Stream | | Mass flow | component to be |
| number | Stream description | [kg/h] | separated off |
| 1 | Fresh feed | 5.58 | |
| 3 | Pure TBA | 2.23 | 98 ppm by mass of |
| | | | water |
| 6 | Distillate from column 2 | 10.26 | |
| 9 | Permeate | 0.33 | 3.0% by mass of TBA |
| 11 | Retenate | 9.93 | |
| 13 | Distillate from column | 2.56 | |
| | 12 | | |
| 14 | Water which has been | 3.35 | 500 ppm by mass of |
| | separated off | | TBA |
| 1 + 9 | Feed to column 12 | 5.91 | |
| 13 + 11 | Feed to column 2 | 12.49 | |

The pressure of the distillate stream (6) at the membrane was 1 bar and the pressure of the meate (9) at the membrane was 0.055 bar.

1. A process for separating off water from a tert-butanol (TBA)/water mixture by
a) distilling the TBA/water mixture to give a TBA/water azeotrope and a water-free TBA stream,
b) separating the water from the TBA/water azeotrope by means of a membrane to give a stream comprising predominantly TBA and a stream comprising predominantly water and
c) recirculating the stream comprising predominantly TBA to the distillation of stage a).

2. The process as claimed in claim 1, wherein, prior to the distillation of stage a), the TBA/water mixture is fractionated to give an aqueous bottom product and a TBA-containing top product which is fed to the distillation of stage a).

3. The process as claimed in claim 1, wherein the recirculation of the stream comprising predominantly TBA in stage c) is wholly or partly to the membrane separation of stage b).

4. The process as claimed in claim 1, wherein the stream comprising predominantly water from stage b) is fractionated to give a TBA/water azeotrope and water and the TBA/water azeotrope is recirculated to the distillation of stage a) and/or to the membrane separation of stage b).

5. The process as claimed in claim 1, wherein the membrane separation of stage b) is carried out by pervaporation.

6. The process as claimed in claim 1, wherein the membrane separation of stage b) is carried out by vapor permeation.

7. The process as claimed in claim 1, wherein the membrane separation of stage b) is carried out by vapor permeation and pervaporation.

8. The process as claimed in claim 1, wherein the water-free TBA stream obtained in stage a) has a water content of 10-5000 ppm by mass.

9. The process as claimed in claim 1, wherein the stream comprising predominantly water obtained in stage b) has a TBA content of from 10 to 0.5% by mass.
